(19) United States
(12) Patent Application Publication
(10) Pub. No.: US 2017/0008341 A1
(43) Pub. Date: Jan. 12, 2017

(54) NON-PNEUMATIC TIRE INCLUDING SHEAR MODULE

(71) Applicant: CATERPILLAR INC., PEORIA, IL (US)

(72) Inventor: KEVIN L. MARTIN, WASHBURN, IL (US)

(73) Assignee: CATERPILLAR INC., PEORIA, IL (US)

(21) Appl. No.: 14/796,410

(22) Filed: Jul. 10, 2015

(51) Int. Cl. B60C 7/10

(52) U.S. Cl. CPC B60C 7/10; B60C 2007/107

(57) ABSTRACT

A non-pneumatic tire may include an inner circumferential barrier configured to be associated with a hub, and an outer circumferential barrier radially exterior relative to the inner circumferential barrier and configured to be associated with a tread portion of the tire. The tire may also include at least one shear module between the inner circumferential barrier and the outer circumferential barrier. The at least one shear module may include a first reinforcement element, a second reinforcement element, and a separator between the first reinforcement element and the second reinforcement element.

### TECHNICAL FIELD

The present disclosure relates to non-pneumatic tires, and more particularly, to non-pneumatic tires including a shear module.

### BACKGROUND

Machines such as vehicles, either self-propelled or pushed or pulled, often include wheels for facilitating travel across terrain. Such wheels often include a tire to protect a rim or hub of the wheel, provide cushioning for improved comfort or protection of passengers or cargo, and provide enhanced traction via a tread of the tire. Non-pneumatic tires are an example of such tires.

Non-pneumatic tires, such as solid tires or tires not retaining pressurized air, may have advantages relative to pneumatic tires because they do not retain air under pressure. However, non-pneumatic tires may suffer from a number of possible drawbacks. For example, non-pneumatic tires may be relatively heavy and may not have a sufficient ability to provide a desired level of cushioning. For example, some non-pneumatic tires may provide little, if any, cushioning, potentially resulting in discomfort to passengers and/or damage to cargo. In addition, some non-pneumatic tires may not be able to maintain a desired level of cushioning when the load changes on the tire. In particular, if the structure of the non-pneumatic tire provides the desired level of cushioning for a given load, it may not be able to continue to provide the desired level of cushioning if the load is changed. For example, if the load is increased, the structure of the non-pneumatic tire may collapse, resulting in a loss of the desired level of cushioning or potentially damaging the tire. If the load is decreased, the level of cushioning may also decrease, resulting in an undesirable reduction in comfort and/or protection. In addition, conventional non-pneumatic tires that provide adequate cushioning may not be able to maintain the desired machine height when loaded due to collapse of the tire under load. Thus, it may be desirable to provide a non-pneumatic tire that provides a desired combination of cushioning and support.

An example of a non-pneumatic wheel is disclosed in U.S. Pat. No. 8,883,283 B2 to Delfino et al. (“the '283 patent”), In particular, the '283 patent discloses a non-pneumatic resilient wheel including a hub and a deformable cellular structure forming a shear band. The shear band includes an upper band and a lower band. Connecting the two bands together in anchoring zones are a series of cylindrical structures including a plurality of concentric elementary cylinders having their generatrix oriented along an axis. The elementary cylinders are fitted one inside the other and interconnected to one another in each anchoring zone. The elementary cylinders are composite cylinders including fibers embedded in a resin matrix.

Although the non-pneumatic wheel disclosed in the '283 patent provides a non-pneumatic wheel purportedly able to operate in a wide variety of temperatures and prevent separation of various portions of the wheel from one another, it may suffer from a number of drawbacks associated with non-pneumatic tires. For example, the wheel disclosed in the '283 patent may not be able to maintain a desired level of cushioning when the load on the wheel changes. Further, the wheel is relatively complex and may be difficult to manufacture on a large scale due to the mechanical interconnections between parts, for example, in the anchoring zones.

The non-pneumatic tires disclosed herein may be directed to mitigating or overcoming one or more of the possible drawbacks set forth above.

### SUMMARY

In one aspect, the present disclosure is directed to a non-pneumatic tire. The tire may include an inner circumferential barrier configured to be associated with a hub, and an outer circumferential barrier radially exterior relative to the inner circumferential barrier and configured to be associated with a tread portion of the tire. The tire may also include at least one shear module between the inner circumferential barrier and the outer circumferential barrier. The at least one shear module may include a first reinforcement element, a second reinforcement element, and a separator between the first reinforcement element and the second reinforcement element.

According to another aspect, a wheel may include a hub configured to be coupled to a machine, and a non-pneumatic tire coupled to the hub. The tire may include an inner circumferential barrier coupled to the hub, and an outer circumferential barrier radially exterior relative to the inner circumferential barrier and configured to be associated with a tread portion of the tire. The tire may also include at least one shear module between the inner circumferential barrier and the outer circumferential barrier. The at least one shear module may include a first reinforcement element, a second reinforcement element, and a separator between the first reinforcement element and the second reinforcement element.

### BRIEF DESCRIPTION OF THE DRAWINGS

FIG. 1 is a perspective view of an exemplary embodiment of a wheel including an exemplary embodiment of a non-pneumatic tire.

FIG. 2 is a side view of the exemplary wheel shown in FIG. 1.

FIG. 3 is a side view of another exemplary embodiment of a wheel including another exemplary embodiment of a non-pneumatic tire.

FIG. 4 is a side view of another exemplary embodiment of a wheel including another exemplary embodiment of a non-pneumatic tire.

FIG. 5 is a cross-sectional view of an exemplary embodiment of a reinforcement cord.

FIG. 6 is a cross-sectional view of an exemplary embodiment of a shear module.

FIG. 7 is a partial section view of another exemplary embodiment of shear modules and surrounding structure shown straightened for clarity.

FIG. 9 is a partial section view of a further exemplary embodiment of shear modules and surrounding structure shown straightened for clarity.

FIG. 10 is a partial section view of another exemplary embodiment of a shear module and surrounding structure shown straightened for clarity.

FIG. 11 is a partial section view of a further exemplary embodiment of a shear module and surrounding structure shown straightened for clarity.

### DETAILED DESCRIPTION

The exemplary tires disclosed herein may be used, for example, for machines configured to travel across terrain. An example of such a machine is a wheel loader. However, the machines may include any type of ground-borne vehicle, such as, for example, an automobile, a truck, an agricultural vehicle, and/or a construction vehicle, such as, for example, a dozer, a skid-steer loader, an excavator, a grader, an on-highway truck, an off-highway truck, and/or any other vehicle type known to a person skilled in the art. In addition to self-propelled machines, the machines may be any device configured to travel across terrain via assistance or propulsion from another machine.

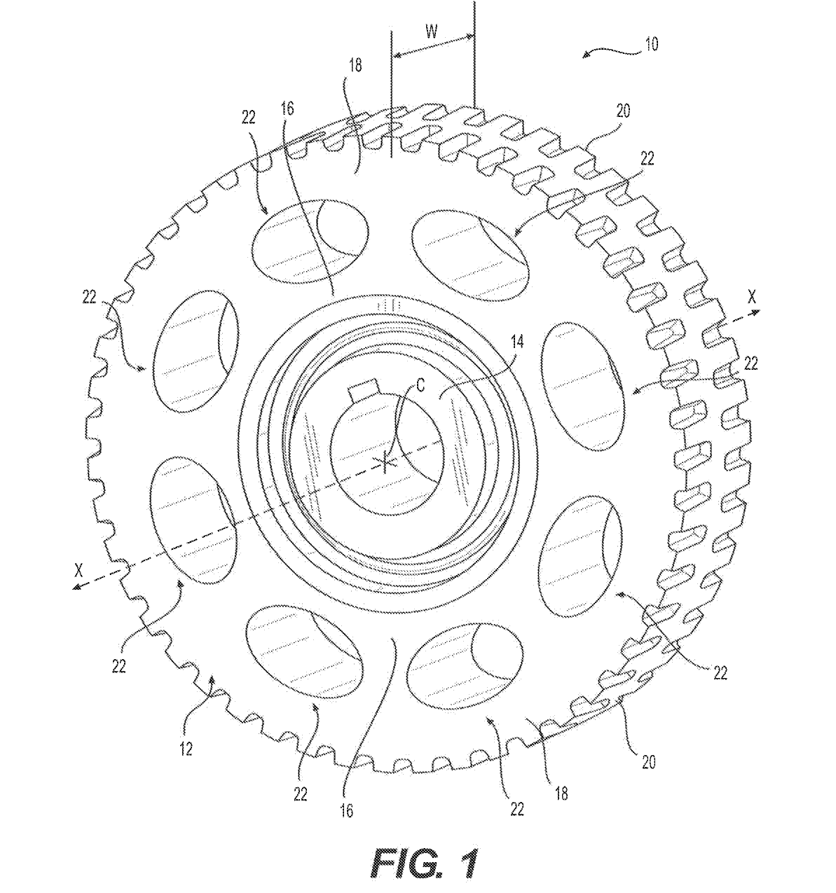

FIG. 1 shows an exemplary embodiment of a wheel 10 including an exemplary embodiment of a non-pneumatic tire 12. As shown in FIG. 1, exemplary wheel 10 includes a hub 14 configured to be coupled to a machine, for example, a powertrain of a machine.

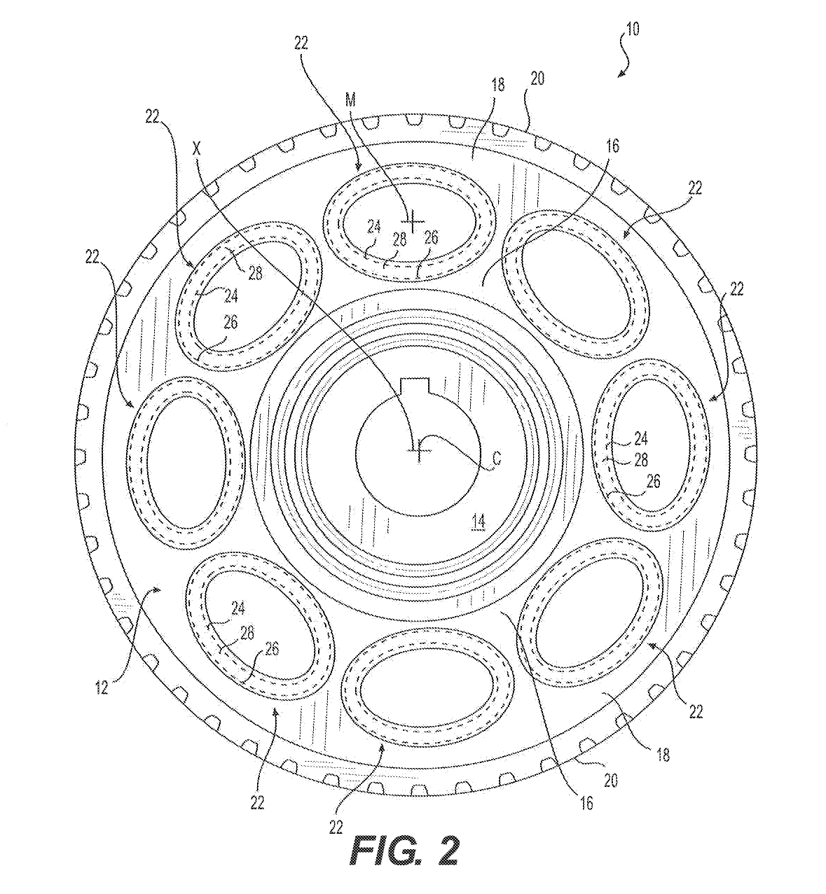

Exemplary tire 12 shown in FIGS. 1 and 2 includes an inner circumferential barrier 16 configured to be coupled to hub 14, and an outer circumferential barrier 18 radially spaced from, and radially exterior relative to, inner circumferential barrier 16, and associated with a tread portion 20 of tire 12. Tread portion 20 of tire 12 may be configured to improve the traction of tire 12 at the interface between tire 12 and the terrain across which tire 12 rolls about an axis of rotation X.

Exemplary tire 12 also includes at least one shear module 22 between inner circumferential barrier 16 and outer circumferential barrier 18. According to some embodiments, at least one shear module 22 may extend between inner circumferential barrier 16 and outer circumferential barrier 18 (e.g., and contact inner circumferential barrier 16 and/or outer circumferential barrier 18). According to some embodiments, for example, as shown in FIGS. 2-4, at least one shear module 22 may include a first reinforcement element 24, a second reinforcement element 26, and a separator 28 between first reinforcement element 22 and second reinforcement element 24. Although not visible in FIG. 1, the exemplary embodiment of tire 12 shown in FIG. 1 may include shear modules 22 having a first reinforcement element 24, a second reinforcement element 26, and a separator 28 between first reinforcement element 22 and second reinforcement element 24.

According to some embodiments, inner circumferential barrier 16, outer circumferential barrier 18, tread portion 20, and/or shear module(s) 22 may be integrally formed as a single, monolithic piece, for example, via molding. However, it is also contemplated that inner circumferential barrier 16, outer circumferential barrier 18, tread portion 20, and/or shear module(s) 22 may be formed separately and thereafter coupled to one another via adhesives and/or mechanical methods (e.g., via fasteners and/or complementary portions on adjacent parts). According to some embodiments, one or more of inner circumferential barrier 16, outer circumferential barrier 18, tread portion 20, and/or shear module(s) 22 may be pre-formed and placed together in a mold that is heated to cure tire 12 as a single piece. For example, one or more of inner circumferential barrier 16, outer circumferential barrier 18, tread portion 20, and/or shear module(s) 22 may be green-cured (i.e., heated a sufficient amount to be partially cured) and thereafter placed in the mold together and heated to a sufficient temperature and for a sufficient duration to complete the curing process.

Tire 12 may be configured to provide a desired amount of traction and cushioning between a machine supported by one or more tires 12 and the terrain. For example, inner circumferential barrier 16, outer circumferential barrier 18, shear module(s) 22, and tread portion 20 may be configured to support a machine in a loaded, partially loaded, and empty condition, such that a desired amount of traction and/or cushioning is provided for the machine, regardless of the load.

For example, if the machine is a wheel loader, when a bucket of the wheel loader is empty, the load on one or more of wheels 10 may range from about 60,000 lbs. to about 160,000 lbs. (e.g., 120,000 lbs.) In contrast, with the bucket loaded with material, the load on one or more of wheels 10 may range from about 200,000 lbs. to about 400,000 lbs. (e.g., 350,000 lbs.). Tire 12 may be configured to provide a desired level of traction and cushioning, regardless of whether the bucket is loaded, partially loaded, or empty. For smaller machines, correspondingly lower loads are contemplated. For example, for a skid-steer loader, the load on one or more of wheels 10 may range from about 1,000 lbs. empty to about 3,000 lbs. (e.g., 2,400 lbs.) loaded.

According to some embodiments, tire 12 may be configured such that it responds to load in a manner similar to a compression wheel. For example, load supported by tire 12 at hub 14 is supported primarily in compression rather than primarily in tension. Referring to FIG. 2, for example, a load supported by tire 12 acts at hub 14, which, in turn, acts on inner circumferential barrier 16. Inner circumferential barrier 16 presses downward (as shown in FIG. 2) on shear modules 22 located below hub 14, such that shear modules 22 below hub 14 are in compression. In contrast, shear modules 22 located above hub 14 support relatively little, if any, of the load, and would be in tension. Thus, outer circumferential barrier 18, shear modules 22, and tread portion 20 located below hub 14, support the load on hub 14 via shear modules 22 located below hub 14 primarily in compression.

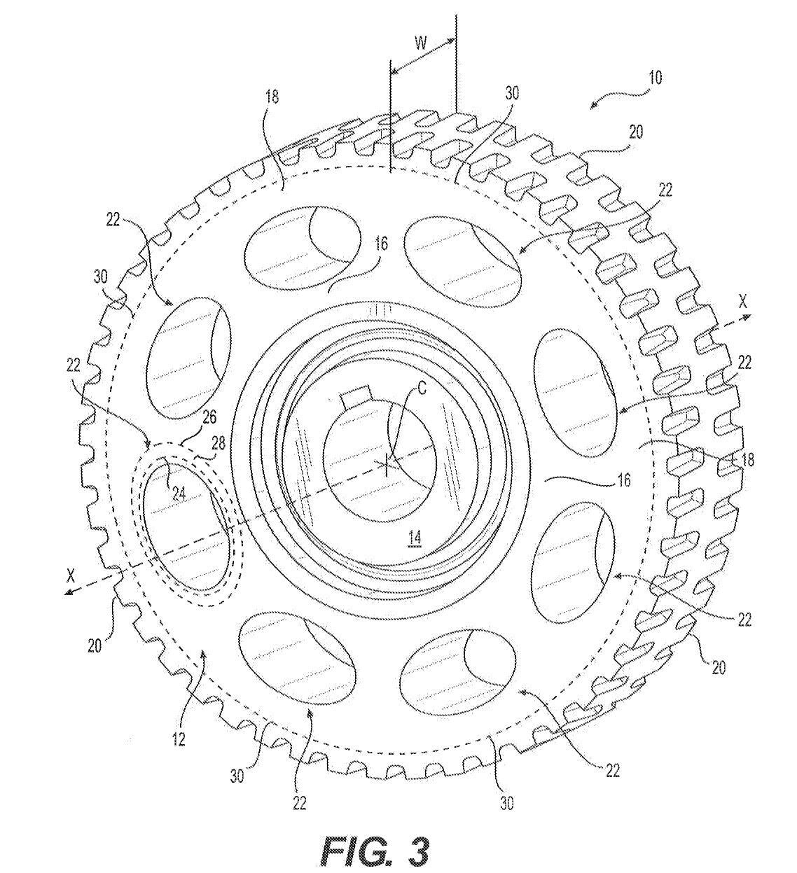

The exemplary wheel 10 shown in FIG. 3 includes an exemplary tire 12 that may include a reinforcement band 30 radially spaced from, and exterior relative to, at least one shear module 22 and radially interior with respect to tread portion 20. Reinforcement band 30 may be configured to more uniformly distribute load applied to shear modules 22 (e.g., when traversing a protrusion or rock) and/or to protect shear modules 22 from damage (e.g., cuts). According to some embodiments, reinforcement band 30 includes at least one circumferentially extending reinforcement cord 32, for example, associated with (e.g., within) outer circumferential barrier 18. In addition, as shown in FIG. 5, at least one reinforcement cord 32 may include a wire rope 34 including a plurality of spirally-wrapped wires 36. At least one reinforcement cord 32, wire rope 34, and/or wires 36 may be formed from any material having a relatively high tensile strength, such as, for example, steel, stainless, steel, aramid fiber, KEVLAR®, carbon fiber, polymer fiber, and/or any combinations thereof.

According to some embodiments, for example, as shown in FIGS. 2-4, separator 28 of shear modules 22 is coextensive (e.g., axially coextensive) with first reinforcement element 24 and second reinforcement element 26. According to some embodiments, separator 28 may be configured to prevent first reinforcement element 24 and second reinforcement element 26 from contacting one another. In the exemplary embodiment shown in FIGS. 2-4, exemplary shear modules 22 are in the form of an elongated tubular element having an elliptical or oval-shaped cross-section parallel to an equatorial plane of tire 12 that is perpendicular to axis of rotation X (see FIG. 1), such that shear modules 22 have a longitudinal axis M extending substantially parallel to axis of rotation X. It is contemplated that shear module(s) 22 may have different forms.

According to some embodiments, shear module 22 may be configured to serve one or more of several possible functions. For example, shear module 22 or a plurality of shear modules 22 may be configured to provide a relatively more rigid hoop-shaped structure between inner circumferential barrier 16 and tread portion 20. This may provide more support for a load applied to hub 14 by a machine, with shear modules 22 between hub 14 and the terrain supporting the load in compression. Shear modules 22 may also result in reducing the weight of tire 12 while still providing sufficient support and cushioning, particularly in the outer circumferential portion of tire 12. Because shear modules 22, for example, in the exemplary embodiments shown, are located in the outer circumferential portion of tire 12 to provide support adjacent tread portion 20, and include a portion not including the material from which tire 12 is formed, a solid or substantially solid tire between inner circumferential barrier 16 and tread portion 20 would require a substantial amount of material, adding significant weight and hence significant rotational inertia to the tire. Shear modules 22 may significantly reduce the weight and material cost relative to such a tire while still providing desired support and cushioning.

According to some embodiments, at least one of first reinforcement element 24 and second reinforcement element 26 of shear module(s) 22 includes at least one module reinforcement cord 38. For example, as shown in FIGS. 2-4, both first reinforcement element 24 and second reinforcement element 26 include at least one module reinforcement cord 38. FIG. 3 depicts only a single shear module 22 that has first and second reinforcement elements 24 and 26, but it should be understood that the exemplary embodiment shown in FIG. 3 may include more than one shear module 22 (e.g., all shear modules 22) that has first and second reinforcement elements 24 and 26. According to some embodiments, both exemplary first reinforcement element 24 and second reinforcement element 26 may include a plurality of module reinforcement cords 38, which may be present axially across the width W of tire 12. According to some embodiments, reinforcement elements 24 and/or 26 may be a single cord spirally-wrapped circumferentially within shear module 22. As shown in FIG. 5, one or more (e.g., each) of module reinforcement cords 38 may include a wire rope 34 including a plurality of spirally-wrapped wires 36. Module reinforcement cords 38, wire rope 34, and/or wires 36 may be formed from any material having a relatively high tensile strength, such as, for example, steel, stainless, steel, aramid fiber, KEVLAR®, carbon fiber, polymer fiber, and/or any combinations thereof.

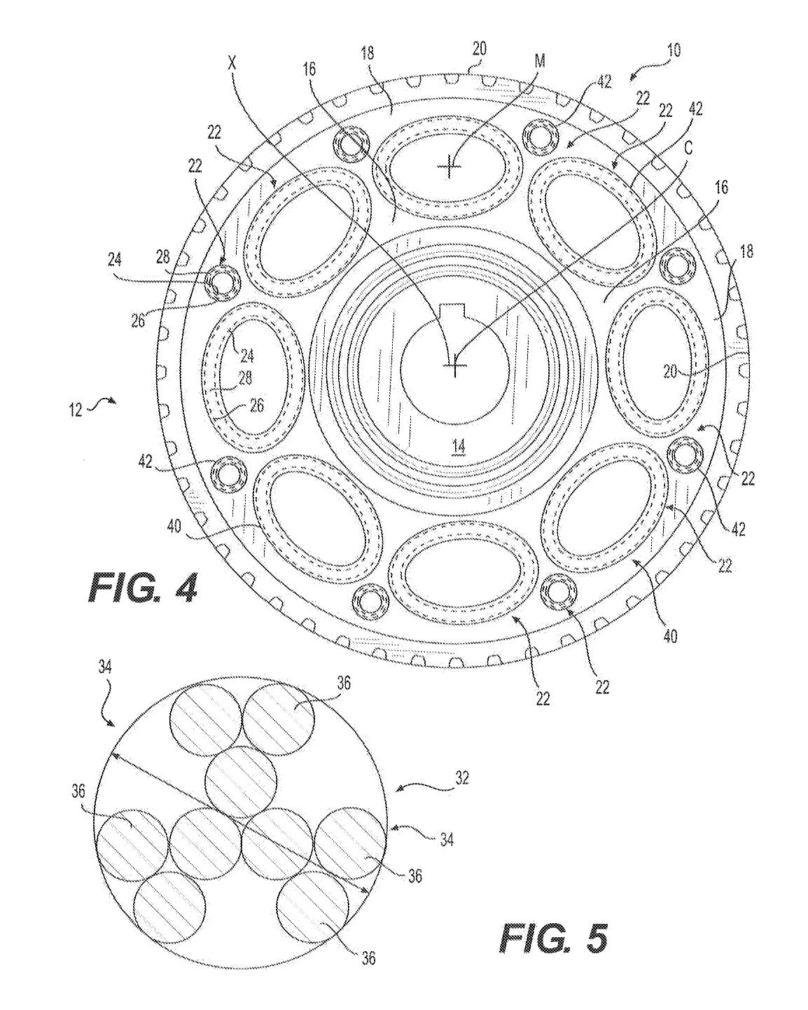

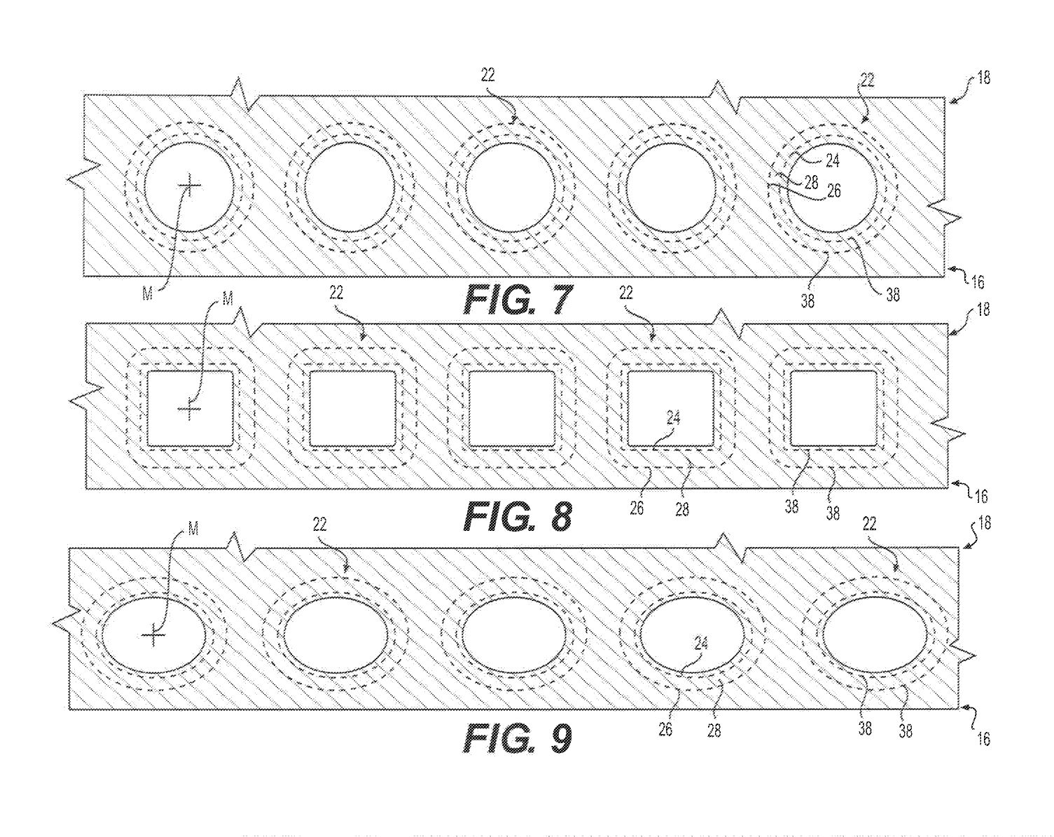

According to the exemplary embodiments shown in FIGS. 1-4, tire 12 may include a plurality of shear modules 22, and the plurality of shear modules 22 may be positioned circumferentially about tire 12. According to some embodiments, at least some of the plurality of shear modules 22 are circumferentially spaced from one another about tire 12, for example, as shown in FIGS. 1-4, such that one or more of shear modules 22 do not contact another one of the plurality of shear modules 22. For example, as shown in FIGS. 2 and 4, the material forming the portion of tire 12 between hub 14 and tread portion 20 fills the space between circumferentially adjacent shear modules 22, such that circumferentially adjacent shear modules 22 do not contact one another directly. For example, FIG. 7 shows exemplary shear modules 22 in a straightened form (rather than circular form) for clarity, along with surrounding structure of tire 12. According to some embodiments, the surrounding structure shown in FIGS. 7-11 may include one or more of inner and outer circumferential barriers 16 and 18. According to some embodiments, at least some of circumferentially adjacent shear modules 22 contact one another directly. For example, each of shear modules 22 may contact two adjacent shear modules 22 located on circumferentially opposite sides of a shear module 22. According to some embodiments, shear modules 22 that contact circumferentially adjacent shear modules 22 may result in a relatively more rigid tire 12 than a tire where adjacent shear modules 22 do not contact another shear module 22 directly.

As shown in FIGS. 1-4 and 7-9, some embodiments include shear modules 22 that are tubular and have a longitudinal axis M extending transverse to an equatorial plane of the tire perpendicular to axis of rotation X of tire 12. For example, FIGS. 1-4 and 7-9 show exemplary shear modules 22 having an elliptical- or oval-shaped cross-section (FIGS. 1-4 and 9), a circular cross-section (FIGS. 4 and 7), and a square-shaped cross-section (FIG. 8). Shear modules 22 having different cross-sectional shapes are contemplated. For example, according to some embodiments one or more of shear modules 22 may have a cross-section parallel relative to the equatorial plane that is polygonal-shaped.

According to some embodiments, at least one shear module 22 includes a plurality of first shear modules and a plurality of second shear modules, and the first shear modules differ in at least one of size and shape relative to the second shear modules. For example, exemplary tire 12 shown in FIG. 4 includes two sets of shear modules 22, including a set of relatively larger, elliptical- or oval-shaped shear modules 40 and a set of relatively smaller, circular-shaped shear modules 42, both circumferentially spaced about tire 12 between inner circumferential barrier 16 and tread portion 20. In the exemplary embodiment shown, circular-shaped shear modules 42 are spaced farther from center C of tire 12 than elliptical- or oval-shaped shear modules 40. Other combinations of configurations are contemplated.

In the exemplary embodiments shown, first reinforcement element 24 is interior relative to separator 28, and second reinforcement element 26 is exterior relative to separator 28. According to some embodiments, at least one of first reinforcement element 24 and second reinforcement element 26 is encapsulated. For example, in the exemplary embodiments shown in FIGS. 2 and 4, first reinforcement element 24 is covered with material (e.g., polyurethane or similar material) on a side opposite separator 28, and second reinforcement element 26 is covered with material (e.g., polyurethane or similar material) on a side opposite separator 28, such that first reinforcement element 24 and second reinforcement element 26 are encapsulated.

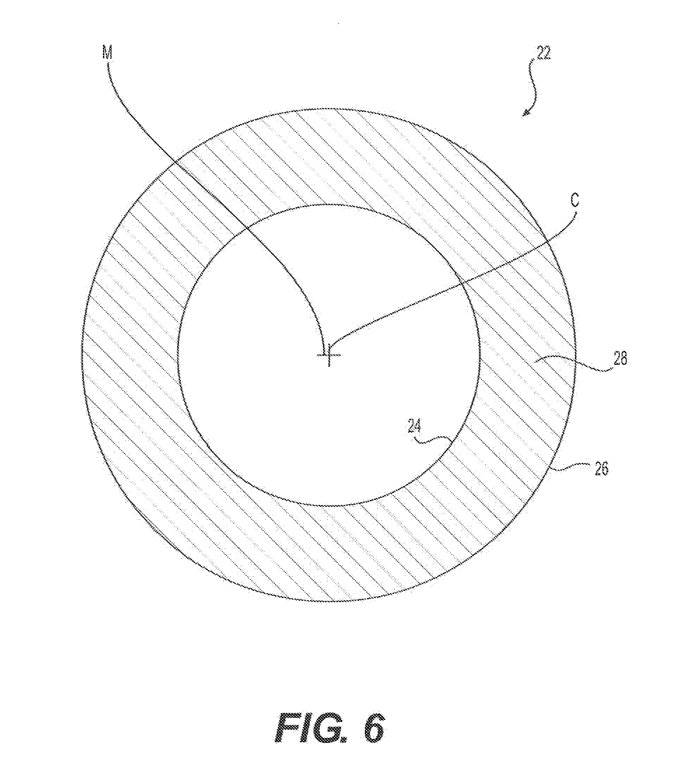

According to some embodiments, at least one of first reinforcement element 24 and second reinforcement element 26 are not encapsulated. For example, as shown in FIG. 6, first reinforcement element 24 and second reinforcement element 26 are not covered with material, except by the material of exemplary separator 28. Thus, the exteriors of first reinforcement element 24 and second reinforcement element 26 are exposed, except to the extent that once incorporated into the remainder of tire 12, second reinforcement element 26 is covered with material forming other portions of tire 12. According to some embodiments, first and/or second reinforcement elements 24 and 26 shown in FIG. 6 may be tubular elements, such as, for example, steel tubular elements sandwiching separator 28. According to some embodiments, first and/or second reinforcement elements 24 and 26 may be a spirally-wrapped wire, such as, for example, a wire at least similar to wire rope 34 shown in FIG. 5.

According to some embodiments, at least one of first reinforcement element 24 and second reinforcement element 26 includes at least one module reinforcement cord 38. For example, at least one module reinforcement cord 38 may be spirally-wrapped with respect to separator 28. According to some embodiments, first reinforcement element 24 and second reinforcement element 26 each include at least one module reinforcement cord 38, for example, a spirally-wrapped wire, such as, for example, a wire at least similar to wire rope 34 shown in FIG. 5. According to some embodiments, first reinforcement element 24 and second reinforcement element 26 may include a reinforcement cord wrapped around the interior and exterior of separator 28.

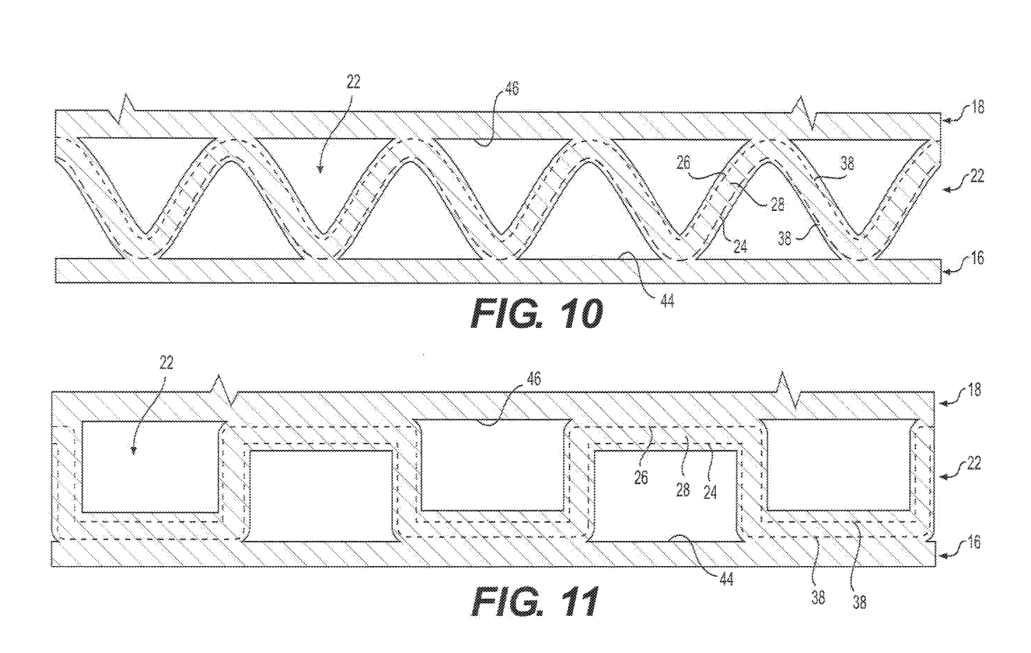

As shown in FIGS. 10 and 11, tire 12 may include a single shear module 22 (shown straightened for clarity), and single shear module 22 intermittently (e.g., alternatingly) contacts a radially external surface 44 of an inner portion of tire 12, such as, for example, inner circumferential barrier 16, and a radially internal surface 46 of an outer portion of tire 12, such as, for example, outer circumferential barrier 18. For example, exemplary shear modules 22 shown in FIGS. 10 and 11 each form a waveform as shear module 22 extends between radially external surface 44 and radially internal surface 46. The waveform may include at least one of a sine waveform, a square waveform, and a triangular waveform. Other waveforms are contemplated.

As shown in FIGS. 1-4 and 7-9, according to some embodiments, portions of tire 12 between shear modules 22 may be partially or completely filled with material fanning tire 12. In such embodiments, shear modules 22 may be essentially encapsulated or surrounded by the material, except at the longitudinal ends of shear modules 22. According to some embodiments, the longitudinal ends may be partially or completely covered, for example, to prevent ingress of material into shear modules 22. According to some embodiments, the material between adjacent shear modules 22 may extend axially for substantially (e.g., all) the width W of tire 12. According to some embodiments, the material between adjacent shear modules 22 may extend axially only partially across the width W of tire 12.

According to some embodiments, at least one of inner circumferential barrier 16, outer circumferential barrier 18, at least one shear module 22, the portions of tire 12 between shear modules 22, and tread portion 20 may be at least partially formed from an elastically deformable material, such as, for example, at least one polymer selected from the group consisting of polyurethane, natural rubber, synthetic rubber, and combinations thereof. According to some embodiments, different parts of tire 12 may be formed from different materials. For example, inner circumferential barrier 16, outer circumferential barrier 18, at least one shear module 22, and/or the portions of tire 12 between shear modules 22 may be formed from a first material, and tread portion 20 may be formed from a second material. For such embodiments, one or more of inner circumferential barrier 16, outer circumferential barrier 18, at least one shear module 22, the portions of tire 12 between shear modules 22, and tread portion 22 may be formed separately from one another, and may be coupled or joined to one another via known methods, such as, for example, mechanical fastening and/or adhesives. According to some embodiments, inner circumferential barrier 16, outer circumferential barrier 18, at least one shear module 22, the portions of tire 12 between shear modules 22, and tread portion 20 may be formed together as a single piece, for example, via molding.

According to some embodiments, tread portion 20 may be formed from a material different from other portions of tire 12, such that tread portion 20 exhibits different characteristics than the other portions. For example, a second material forming tread portion 20 may provide tread portion 20 with more wear resistance, abrasion resistance, hardness, toughness, and/or a different appearance (e.g., color or texture) than materials used to form other portions of tire 12.

According to some embodiments, shear modules 22 may be formed separately from the other portions of tire 12 and thereafter incorporated into, or coupled to, the other portions of tire 12. For example, shear module 22 may be pre-formed and thereafter placed into a mold for forming other portions of tire 12, with other portions of tire 12 being molded around shear module 22. For example, shear modules 22 may be pre-formed and thereafter placed into a mold for forming other portions of tire 12, with other portions of tire 12 being molded around shear modules 22.

For example, shear modules 22 may be formed by wrapping (e.g., spirally) module reinforcement cord 38 around a mandrel to create a tube for other configuration) formed by module reinforcement cord 38. Thereafter, a polymer material (e.g., polyurethane or similar material) may be applied around module reinforcement cord 38 to form separator 28. Thereafter, a second module reinforcement cord 38 may be wrapped (e.g., spirally) around separator 28. According to some embodiments, polymer (e.g., polyurethane or similar material) may be applied to the exposed surfaces one or both of module reinforcement cords 38, thereby encapsulating module reinforcement cords 38.

According to some embodiments, the polymer (e.g., polyurethane or similar material) of shear module 22 may be partially cured for complete curing when incorporated into other portions of tire 12. For example, the polymer of shear modules 22 may be partially cured by heating for a predetermined time and temperature, so that the polymer remains partially reactive with a subsequently-supplied polymer that will be molded around the shear modules 22. For example, for polyurethane urea systems using TDDM curative, this may be a temperature ranging from about 110° C. to about 150° C. for a duration ranging from about 2 hours to about 6 hours (e.g., at 130° C. for 4 hours). Thereafter, the partially cured shear modules 22 may be added to a mold for forming other portions of tire 12, so that shear modules 22 may be molded into the remaining portions of tire 12. Subsequently, after the polymer used to form the remainder of time 12 has been added to the mold, the entire tire 12 including the shear modules 22 may be completely cured to form tire 12. For example, for polyurethane urea systems using TDDM as a curative, curing of the polymer of tire 12 may be performed by heating time 12 at a temperature ranging from about 120° C. to about 160° C. for a duration ranging from about 6 hours to about 48 hours (e.g., at 140° C. for 24 hours). Thereafter, the completely cured tire may be removed from the mold.

According to some embodiments, tire 12 may be configured such that the axial width of tire 12 varies in a radial direction between hub 14 and tread portion 20. For example, tire 12 may have an inner axial width associated with inner circumferential barrier 16 (e.g., adjacent hub 14) and an outer axial width associated with outer circumferential barrier 18 (e.g., adjacent tread portion 20), where the outer axial width is greater than the inner axial width. For example, the ratio of the outer axial width to the inner axial width may range from 1:1 to 3.5:1. In some embodiments, the ratio of the outer axial width to the inner axial width may range from 1.2:1 to 3.5:1, for example, from 1.4:1 to 2.8:1. According to some embodiments, the radial cross-section of tire 12 between hub 14 and tread portion 20 defines a trapezoid. According to some embodiments, the axial width of tire 12 may not vary significantly between hub 14 and tread portion 20, for example, as shown in FIGS. 1 and 3.

Tire 12 may have dimensions tailored to the desired performance characteristics based on the expected use of the tire. For example, tire 12 may have a width at tread portion 20 ranging from 0.1 meter to 2 meters (e.g., 1 meter), an inner diameter for coupling with hub 14 ranging from 0.5 meters to 4 meters (e.g., 2 meters), and an outer diameter ranging from 0.75 meter to 6 meters (e.g., 4 meters). According to some embodiments, the ratio of the inner diameter of tire 12 to the outer diameter of tire 12 ranges from 0.25:1 to 0.75:1, or 0.4:1 to 0.6:1, for example, about 0.5:1. Tire 12 may have an axial width ranging from 0.05 meters to 3 meters. Other dimensions are contemplated. For example, for smaller machines, correspondingly smaller dimensions are contemplated.

### INDUSTRIAL APPLICABILITY

The non-pneumatic tires disclosed herein may be used with any machines, including self-propelled vehicles or vehicles intended to be pushed or pulled by another machine. According to some embodiments, the non-pneumatic tires disclosed herein may overcome or mitigate potential drawbacks associated with prior non-pneumatic tires.

For example, relative to prior non-pneumatic tires, the non-pneumatic tires disclosed herein may be relatively lighter in weight, and may have an ability to provide a desired level of cushioning, regardless of whether the load on the tire changes significantly. This may be desirable when non-pneumatic tires are installed on machines that carry loads of widely varying magnitude. For example, the tires of a wheel loader or haul truck may be subjected to a relatively light load when not carrying a load of material, but a relatively high load when carrying a load of material. The non-pneumatic tires disclosed herein may be able to provide a desirable level of cushioning and/or traction in both conditions. In addition, at least some embodiments of the non-pneumatic tires disclosed herein may be relatively more durable due to the configuration of the shear modules. The exemplary shear modules disclosed herein may prevent or reduce the likelihood of the support structure collapsing when loaded, which, in turn, may increase the service life of the tire.

It will be apparent to those skilled in the art that various modifications and variations can be made to the exemplary disclosed tires and wheels including the tires. Other embodiments will be apparent to those skilled in the art from consideration of the specification and practice of the exemplary disclosed embodiments. It is intended that the specification and examples be considered. as exemplary only, with a true scope being indicated by the following claims and their equivalents.

What is claimed is:

1. A non-pneumatic tire comprising:
an inner circumferential barrier configured to be associated with a hub;
an outer circumferential barrier radially exterior relative to the inner circumferential barrier and configured to be associated with a tread portion of the tire; and
at least one shear module between the inner circumferential barrier and the outer circumferential barrier, the at least one shear module including:
a first reinforcement element;
a second reinforcement element; and
a separator between the first reinforcement element and the second reinforcement element.

2. The tire of claim 1, wherein at least one of the first reinforcement element and the second reinforcement element includes at least one module reinforcement cord.

3. The tire of claim 2, wherein the at least one module reinforcement cord includes a plurality of module reinforcement cords.

4. The tire of claim 2, wherein the at least one module reinforcement cord includes a wire rope including a plurality of spirally-wrapped wires.

5. The tire of claim 1, wherein the at least one shear module includes a plurality of the shear modules, and wherein the plurality of shear modules are positioned circumferentially about the tire.

6. The time of claim 5, wherein the plurality of the shear modules are circumferentially spaced from one another about the tire.

7. The tire of claim 5, wherein at least some circumferentially adjacent shear modules contact one another.

8. The tire of claim 5, wherein the shear modules are tubular and have a longitudinal axis extending transverse to an equatorial plane of the tire perpendicular to an axis of rotation of the tire.

9. The tire of claim 8, wherein the first reinforcement element is exterior relative to the separator, and the second reinforcement element is interior relative to the separator.

10. The tire of claim 9, wherein at least one of the first reinforcement element and the second reinforcement element is encapsulated.

11. The tire of claim 9, wherein at least one of the first reinforcement element and the second reinforcement element includes at least one module reinforcement cord, and wherein the at least one module reinforcement cord of the at least one reinforcement element is spirally-oriented with respect to the separator.

12. The tire of claim 8, wherein the shear modules have a cross-section parallel relative to the equatorial plane, and the cross-section is one of circular, elliptical, square-shaped, and polygonal-shaped.

13. The tire of claim 1, wherein the at least one shear module intermittently contacts the inner circumferential barrier and the outer circumferential barrier.

14. The tire of claim 13, wherein the at least one shear module forms a waveform as it extends between the inner circumferential barrier and outer circumferential barrier, and wherein the waveform includes at least one of a sine waveform, a square waveform, and a triangular waveform.

15. The tire of claim 1, wherein the at least one shear module includes a plurality of first shear modules and a plurality of second shear modules, and wherein the first shear modules differ in at least one of size and shape relative to the second shear modules.

16. The tire of claim 15, wherein the first shear modules are positioned between the inner circumferential barrier and the outer circumferential barrier at a different radial position than the second shear modules.

17. The tire of claim 1, wherein at least one of the inner circumferential barrier, the outer circumferential barrier, and the at least one shear module is at least partially formed from at least one polymer selected from the group consisting of polyurethane, natural rubber, and synthetic rubber.

18. The tire of claim 1, further including a reinforcement band radially spaced from and exterior relative to the at least one shear module and radially interior with respect to the tread portion, wherein the reinforcement band includes at least one circumferentially extending reinforcement cord.

19. A wheel comprising:
a hub configured to be coupled to a machine; and
a non-pneumatic tire coupled to the hub, the non-pneumatic tire including:
an inner circumferential barrier coupled to the hub;
an outer circumferential barrier radially exterior relative to the inner circumferential barrier and configured to be associated with a tread portion of the tire; and
at least one shear module between the inner circumferential barrier and the outer circumferential barrier, the at least one shear module including:
a first reinforcement element;
a second reinforcement element; and
a separator between the first reinforcement element and the second reinforcement element.

20. The wheel of claim 19, wherein the at least one shear module includes a plurality of the shear modules, and wherein the plurality of shear modules are positioned circumferentially about the tire.
